(19) United States
(12) Patent Application Publication
(10) Pub. No.: US 2021/0131658 A1
(43) Pub. Date: May 6, 2021

(54) SEALING MEMBER AND METHOD OF PRODUCING A SEALING MEMBER

(71) Applicant: SIGNIFY HOLDING B.V., Eindhoven (NL)

(72) Inventors: MARK JOHANNES ANTONIUS VERHOEVEN, DEURNE (NL); ERNESTO SIMON JOHAN VAN BEEK, EINDHOVEN (NL); NOUD JOHANNES FLEUREN, BAARLO (NL); GRZEGORZ GALKO, WAALRE (NL); KRISTIEN PAS, EINDHOVEN (NL)

(21) Appl. No.: 16/640,102

(22) PCT Filed: Aug. 20, 2018
(86) PCT No.: PCT/EP2018/072403

§ 371 Date: Feb. 19, 2020

(30) Foreign Application Priority Data
Aug. 24, 2017 (EP) 17187725.1

(51) Int. Cl. F21V 31/00; F21V 15/01

(52) U.S. Cl. CPC F21V 31/005; F16J 15/104; F21V 15/01

(57) ABSTRACT

There is provided a sealing member (100) for providing a sealing between two inter-attachable parts. The seal comprises a band (110) and a sealing element (120). The sealing element comprises a slit (130) in which the band is at least partially accommodated. The sealing element further comprises at least two deformable portions (140a, 140b) oppositely arranged at respective peripheral edge portions (145a, 145b) of the slit.

### FIELD OF THE INVENTION

The present invention generally relates to the field of seals. More specifically, the present invention relates to a seal for enclosures having relatively high demands of protection.

### BACKGROUND OF THE INVENTION

For some applications, it may be highly important to provide adequate sealing properties against dust, accidental contact, water, etc. For example, for lighting applications, there may be a wish to provide a sealing such that one or more conditions of the lighting (e.g. light distribution, thermal dissipation, etc.) does not become negatively affected in case of an insufficient sealing.

In case of a luminaire, there may be a wish to seal the housing of the luminaire for protective reasons as mentioned above. For example, the luminaire may have a sealing (gasket) between a housing and a part intended to be connected to the housing (e.g. glass plate, cover, or the like). The construction may be realized by a rib of the housing onto which a gasket can be placed.

However, there may be cases when the rib of the housing cannot be provided in more than one direction. For example, in case die-casting of the housing is not feasible, and only (aluminum) extrusion is possible, it is often not possible to obtain a rib in more than one direction. To overcome this problem, one possibility is to provide parallel, one-directional ribs, and to place the sections of the ribs as a rectangle with space between the sections. This requires, however, that the gasket to be mounted on the ribs is made via injection molding, which is relatively expensive.

Hence, alternative solutions are of interest which are able to provide a seal, e.g. for lighting applications, wherein the seal may provide adequate sealing properties in a (cost)-efficient and convenient manner.

US20140353917 discloses a seal apparatus with a resilient elongate strip with a U-shaped cross sectional base with extending therefrom two opposing walls enveloping a carrier member.

### SUMMARY OF THE INVENTION

It is an object of the present invention to mitigate the above problems and to provide a seal which is more (cost)-efficient and convenient compared to sealings according to the prior art.

This and other objects are achieved by providing a sealing member, a sealing arrangement, a lighting arrangement and a method.

Hence, according to a first aspect of the present invention, there is provided a sealing member for arrangement between at least two inter-attachable parts. The sealing member comprises a band and a sealing element. The band having two oppositely arranged ridges defining a width W of the band. The sealing element comprises a slit with two seats The sealing element further comprises two deformable portions mutually connected via a support wall and oppositely arranged at respective peripheral edge portions of the slit. The band is at least partially accommodated in the slit with the ridges seated in a respective seat and with the support wall adjacent a major face of the band.

Typically the band has a length, a width and a thickness. Preferably the band is sufficiently rigid in the width direction enabling it to withstand a compressive stress needed for sealing the arrangement. Yet, the band has some flexibility in the length direction, i.e. it can be bend or formed in the desired shape of the arrangement it has to seal. Hence, the band could be made of robust, yet pliant or ductile material like plastic or metal. Furthermore, to render the two deformable portions of sealing element substantially stay in the correct position when subjected to compressive stress for sealing, the support wall of the sealing element is adjacent, and preferably abuts, the major face of the band. Further to this, the sealing element has two mutually oppositely arranged lips extending parallel to the support wall to further enclose or accommodate the band and on either side of an insertion opening for insertion of the band into the sealing element. The support wall, two lips and two grooved seats preferably snugly or tightly enclose the band when at least partly accommodated in the sealing element. Thereto, the grooved seats typically are embodied as bottomed recesses or grooves and the support wall has a height which is the same or substantially the same as the width of the band. The band typically does not extend in the height direction beyond the bottom of the recess/groove to provide the most reliable sealing.

According to a second aspect of the present invention, there is provided a sealing arrangement. The sealing arrangement comprises two inter-attachable parts and a sealing member according to the first aspect of the present invention for providing a sealing between the two inter-attachable parts. The sealing member is arranged between the parts and oriented such that the deformable portions are configured to abut a respective part upon an attachment of the parts.

According to a third aspect of the present invention, there is provided a lighting arrangement. The lighting arrangement comprises a heat sink and an optical element arranged oppositely the heat sink. The lighting arrangement further comprises a light source for generating light, the light source being arranged between the heat sink and the optical element. The lighting arrangement further comprises a sealing member according to the first aspect of the present invention. The sealing member is arranged between the heat sink and the optical element for sealing the light source. The sealing member is oriented such that the deformable portions are configured to abut the respective heat sink and optical element upon an attachment of the heat sink and optical element.

According to a fourth aspect of the present invention, there is provided a method of producing a sealing member. The method comprises the step of providing a band, e.g. a rib, strip or sheet of plastic or metal. The method further comprises the step of extruding a sealing element comprising a slit for at least partially accommodating the band and at least two deformable portions oppositely arranged at respective peripheral edge portions of the slit. Furthermore, the method comprises the step of arranging the sealing element at least partially around the band.

Thus, the present invention is based on the idea of providing a self-sustainable seal (gasket) comprising a band or rib enveloped by a sealing element or gasket, whereby a sealing between two inter-connectable (inter-attachable) parts may be provided in an efficient and convenient manner. By arranging the sealing member between the two parts and orienting the sealing member such that the deformable portions are configured to abut a respective part upon attachment of the parts, the deformable portions of the sealing element are configured to become compressed and/or clamped by the parts upon attachment of the parts, and at least partially deform. As a result, the sealing member may achieve efficient sealing properties between the parts to be attached.

The present invention is advantageous in that the sealing member is relatively cost-efficient regarding its relatively straight-forward, yet innovative construction. The cost-efficiency of the sealing member may be even further substantiated by selection of relatively inexpensive materials for the sealing member.

The present invention is further advantageous in that the sealing member may be obtained or provided in more than one direction. For example, in case a rib for sealing properties is extruded on a part, element and/or housing, it is usually not possible to provide the rib in more than one direction. Consequently, portions of the seal may be missing and/or techniques such as injection molding may have to be applied, leading to relatively expensive and/or circumstantial operations. The sealing member of the present invention, on the other hand, may be provided in substantially any shape (e.g. a round shape), resulting in a convenient, efficient and/or cost-efficient sealing.

The present invention is further advantageous in that the sealing member may be designed for a vast amount of sealing applications. For example, the size and/or the shape of the sealing member may be individually designed for an efficient sealing of parts, elements and/or devices which are to be connected and/or attached to each other.

The sealing member of the present invention comprises a band. By the term “band”, it is here meant a strip, rib, plate, or the like, wherein the band may be relatively flat. The band may also be an extruded aluminum frame. The sealing member further comprises a sealing element comprising a slit in which the band is at least partially accommodated. By the term “slit”, it is here meant an opening, cavity, or the like, in which the band may be arranged. The sealing element further comprises at least two deformable portions. By the term “deformable portions”, it is here meant that the portions are able to deform upon application of a force. The deformable portions are oppositely arranged at respective peripheral edge portions of the slit. In other words, when the sealing member is provided and oriented between two parts to be attached, the deformable portions of the sealing element are configured to face and/or abut the oppositely arranged parts. Consequently, the band and the deformable portions of the sealing member are able to provide excellent sealing properties between the parts.

According to an embodiment of the present invention, the sealing member is annular. By the term “annular”, it is here meant that the sealing member may be circular, oval or even rectangular. The present embodiment is advantageous in that the sealing member may overcome disadvantages related to cost and/or inefficiency regarding sealing arrangements provided in only one direction. Hence, the sealing member of the present embodiment may hereby provide more efficient sealing properties and/or a more cost-efficient sealing. The present embodiment is further advantageous in that the annular sealing member may provide a fully closed seal over the entire circumference of the sealing member.

According to an embodiment of the present invention, at least one of the deformable portions comprises a cavity. In other words, the deformable portion(s) may be tube-shaped. The present embodiment is advantageous in that the cavity(ies), which may be filled with air, may be conveniently deformed in response to an applied clamping force from the part(s) during attachment of the parts. Alternatively, the deformable portions may be formed by solid material, i.e. not comprising any cavity. This may be advantageous in applications where the seal may be subjected to a relatively high compressive stress.

According to an embodiment of the present invention, the band comprises a metal or plastic. The present embodiment is advantageous in that the materials are relatively inexpensive, and that the materials furthermore may be extruded into the band. Furthermore, the band of metal or plastic may be shaped and/or deformed into a desired shape.

According to an embodiment of the present invention, the sealing element comprises a rubber material. By the term “rubber material”, it is here meant (natural or synthetic) rubber(s), silicon(s), or the like. The present embodiment is advantageous in that the rubber material is particularly suitable for sealing properties whilst being relatively inexpensive. The use of a rubber material for the sealing element is further advantageous considering the possibility to extrude the sealing element into a desired shape.

According to an embodiment of the present invention, the deformable portion(s) comprises at least one perforation. By the term “perforation”, it is here meant a hole, opening, or the like. It will be appreciated that the perforation(s) serve as a compression regulator by exhausting air which may be provided inside the deformable portions. In case of an annular sealing member, the perforation(s) are advantageously provided on an inside portion of the sealing member and/or inside an industrial package (IP) protected area. The present embodiment is advantageous in that the sealing properties at the contact area between the part(s) and the deformable portion(s) may be even further improved due to an under-pressure and/or a vacuum obtained in the deformable portions in response to the evacuated air through the perforation(s).

According to an embodiment of the present invention, the sealing arrangement may comprise a frame arranged at a peripheral portion of the parts, wherein the frame is configured to clamp the parts. By the term “frame”, it is here meant an at least partially hollow frame, profile, or the like, e.g. having a U-shape.

According to an embodiment of the present invention, the optical element of the lighting arrangement is a translucent plate.

According to an embodiment of the present invention, the lighting arrangement further comprises a frame arranged at a peripheral portion of the lighting arrangement, wherein the frame is configured to clamp the heat sink and the optical element. In other words, in response to the clamping of the heat sink and the optical element by means of the frame, the sealing member is configured to provide a sealing between the heat sink and the optical element.

According to an embodiment of the present invention, the method further comprises the step of forming the sealing member to an annular sealing member.

According to an embodiment of the present invention, the method further comprises the step of providing a cavity in at least one of the deformable portions.

According to yet another embodiment of the second aspect of the present invention, the method further comprises the step of perforating at least one of the deformable portions of the sealing member comprising a cavity.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiment(s) of the invention.

FIGS. 1a and 1b are schematic views of cross-sections of sealing members according to exemplifying embodiments of the present invention,

FIG. 2 is a schematic view of a sealing member according to an exemplifying embodiment of the present invention,

FIG. 3 is a schematic view of a cross-section of a sealing arrangement according to an exemplifying embodiment of the present invention,

FIG. 4 is a schematic view of a cross-section of a lighting arrangement according to an exemplifying embodiment of the present invention, and

FIG. 5 is a schematic view of a method of producing a sealing member according to an exemplifying embodiment of the present invention.

### DETAILED DESCRIPTION

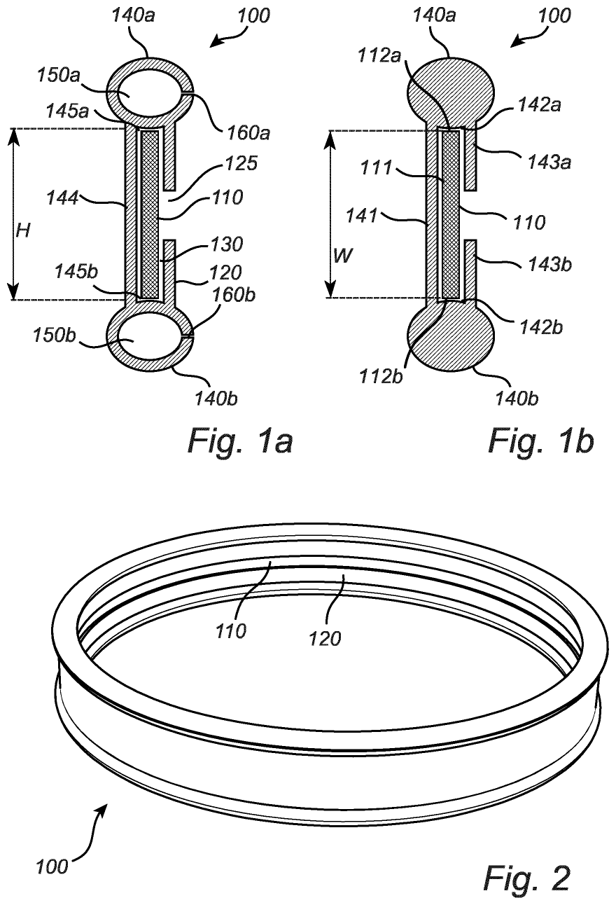

FIG. 1a and FIG. 1b show schematic views of cross-sections of sealing members 100 according to two exemplifying embodiments of the present invention. The sealing member 100 comprises a band 110 which may be formed as a strip, rib, sheet, or the like. The band 110 can also be an extruded aluminum frame. Hence, the band 110 may be relatively thin, and may furthermore comprise plastic(s) and/or metal(s). The band has two elongated oppositely arranged ridges 112a, 112b and a major face 111.

The sealing member 100 further comprises a sealing element 120 which comprises a slit 130 in which the band 110 is at least partially accommodated. In other words, the sealing element 120 may be described as an enclosure, whereby the sealing element 120 may be folded around the band 110. The slit 130 has a slit wall comprising a support wall 141 having essentially the same height H as the width W of the band, and the slit optionally comprising two, mutually oppositely arranged lips 143a, 143b, the slit further comprises an insertion opening 125 and two seats 142a, 142b at peripheral portions 145a, 145b of the slit, and the band 110 is inserted into the slit 130 via the insertion opening 125. The seats typically are embodied as bottomed recesses or grooves. In the embodiment as shown in the figure, the insertion opening is limited in size by the two lips extending parallel to the support wall. The band is accommodated in the slit with a snugly fit.

It will be appreciated that the material of the sealing element 120 may be substantially any material suitable for sealing purposes, such as rubber. Furthermore, the band 110 can be a part of the sealing element 120, e.g. in case the sealing element 120 is (2k) extruded.

The sealing element 120 further comprises two deformable portions 140a, 140b oppositely arranged at respective peripheral edge portions 145a, 145b of the slit 130 and mutually connected by a support wall. Hence, the respective edge portion 145a, 145b of the band 110 faces the respective deformable portion 140a, 140b such that the sealing member 100 has the shape of a dumbbell. In other words, the band 110 and the slit 130 may constitute a central portion of the sealing member 100 and the deformable portions 140a, 140b of the sealing member 100 may constitute peripheral portions of the sealing member 100.

It should be noted that the edges of the band 100 are preferably relatively smooth (i.e. the band 100 may be free from relatively sharp edges). Alternatively, the band 100 may have a specific shape or a shape matching the shape of the peripheral edge portions 145a, 145b of the slit 130 to counteract the band of cutting into the deformable portions 140a, 140b when the sealing member 100 is subjected to a compressive stress for the sealing.

It will be appreciated that the sealing member 100 may be formed as a one-piece sealing member 100, i.e. the sealing element 120 and the two deformable portions 140a, 140b may be connected and/or be made from the same piece of material. Alternatively, the sealing member 100 may comprise two separated sealing portions each comprising a slit 130 and a deformable portion 140a, 140b arranged on opposite edge portions 145a, 145b of the band 110.

According to FIG. 1a, each of the deformable portions 140a, 140b may comprise a respective cavity 150a, 150b. Hence, the deformable portions 140a, 140b may be tube-shaped. The cavities 150a, 150b may be filled with air. The sealing member 100 as exemplified may further comprise one or more perforations 160a, 160b in the deformable portions 140a, 140b. Here, the perforations 160a, 160b are exemplified as relatively small holes in the cavity wall of the deformable portions 140a, 140b, and may hereby be provided on the inside of an industrial package (IP) protected area.

FIG. 1b is a schematic view of a cross-section of a sealing member 100 according to an exemplifying embodiment of the present invention. It will be appreciated that the sealing member 100 of FIG. 1b is similar to the sealing member 100 of FIG. 1a. Due to reasons of simplicity, several references have been omitted, and it is hereby referred to the description of FIG. 1a. However, compared to the sealing member 100 of FIG. 1a, the deformable portions 140a, 140b of the sealing member 100 of FIG. 1b are formed by solid material. In other words, the deformable portions 140a, 140b of the sealing member 100 of FIG. 1b do not comprise any cavities. Furthermore, the deformable portions 140a, 140b of the sealing member 100 of FIG. 1b do not comprise any perforations.

FIG. 2 is a schematic view of a sealing member 100 according to an exemplifying embodiment of the present invention. Here, the band 110 of the sealing member 100 is provided in a relatively round shape, whereby the ends of the band 110 have been connected (e.g. by a metal-adhesive tape). It will be appreciated that the annular sealing member 100 may have substantially any shape, e.g. a circular, oval, rectangular or square shape.

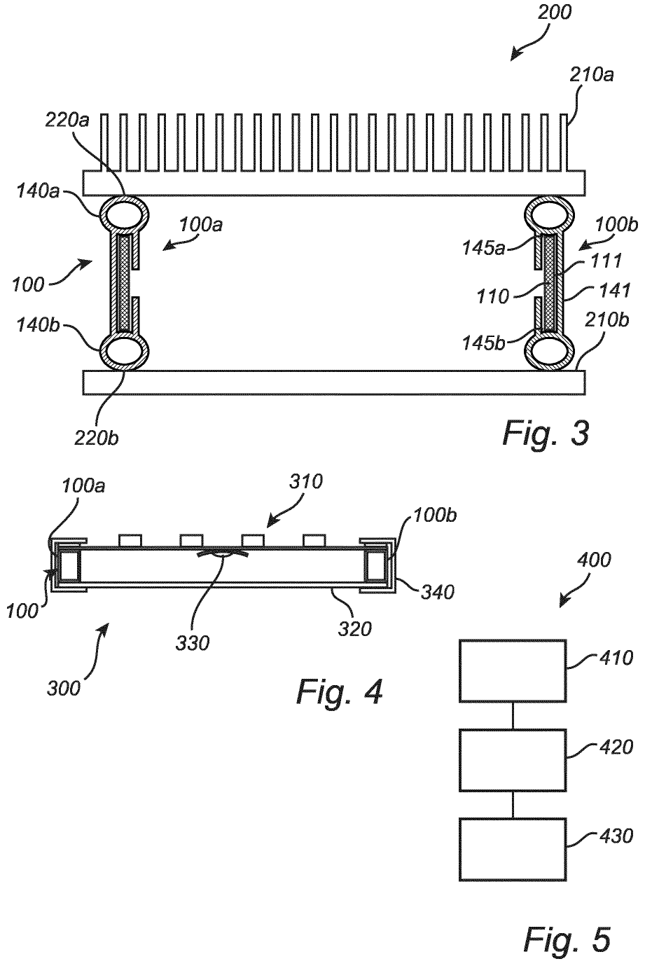

FIG. 3 is a schematic view of a sealing arrangement 200 according to an exemplifying embodiment of the invention. The sealing arrangement 200 comprises two inter-attachable parts 210a, 210b. It will be appreciated that the parts 210a, 210b may constitute substantially any parts, devices and/or elements to be connected. Here, the upper part 210a is exemplified as a heat sink, and the lower part 210b is exemplified as a glass plate. The sealing arrangement 200 further comprises an annular or endless sealing member 100, whereby the sealing member 100 in its depicted cross-section comprises cross-sections 100a, 100b. Similar to FIG. 2, it will be appreciated that the circular, annular sealing member 100 as depicted may alternatively have an oval, rectangular or square shape. The deformable portions 140a, 140b shown in the respective cross-sections 100a, 100b are oppositely arranged at respective peripheral edge portions 145a, 145b of the slit, and are in contact with the parts 210a, 210b at respective areas of contact 220a, 220b of the attachable parts 210a, 210b. In other words, upon attachment of the attachable parts 210a, 210b, the deformable portions 140a, 140b are configured to abut the respective attachable parts 210a, 210b and become clamped by the respective parts 210a, 210b such that they (at least partially) deform and yet the deformable portions stay in the correct position when subjected to compressive stress for sealing, because the support wall 111 of the sealing element is abuts the major face 141 of the band. In this way, the sealing member 100 provides an efficient sealing between the parts 210a, 210b. Although not shown in FIG. 3, it should be noted that the deformable portions 140a, 140b may further comprise one or more perforations as previously described in the exemplifying embodiment of the sealing member associated with FIG. 1.

FIG. 4 is a schematic view of a cross-section of a lighting arrangement 300 according to an exemplifying embodiment of the present invention. The lighting arrangement 300 comprises a heat sink 310, wherein the heat sink 310 for example may be made of extruded aluminum. The lighting arrangement 300 further comprises an optical element 320 arranged oppositely the heat sink 310. Furthermore, the lighting arrangement 300 comprises a light source 330 for generating light, wherein the light source 330 is arranged between the heat sink 310 and the optical element 320. The lighting arrangement 300 further comprises a schematically indicated sealing member 100 (with cross sections 100a, 100b) according to any one of the previously described embodiments. The sealing member 100 is arranged between the heat sink 310 and the optical element 320 for sealing the light source 330 in the lighting arrangement 300, and oriented such that the deformable portions are configured to abut the respective heat sink and optical element upon attachment of the heat sink and the optical element. The sealing member 100 is hereby arranged to provide a sealing between the heat sink 310 and the optical element 320. The lighting arrangement 300 further comprises a frame 340 arranged at a peripheral portion of the lighting arrangement 300. The frame 340, which for example may be a U-shaped frame of stainless steel, is at least partially provided around respective end portions of the heat sink 310 and the glass 320. The frame 340 is hereby configured to clamp the heat sink 310 and the optical element 330, resulting in a sealing at least of the light source 330 of the lighting arrangement 300 from the ambient surrounding by means of the sealing member 100.

FIG. 5 is a schematic flow chart of a method 400 of producing a sealing member. The method 400 comprises the step 410 of providing a band, e.g. a strip, rib or sheet of plastic or metal. For example, the method 400 may comprise the step of cutting a metal band into a certain length and width, or extruding an aluminum frame. In case of an aluminum frame, the frame can be kept in place by fastening means such as one or more screws or pins. As an option, the method 400 may further comprise the step of bending the band into an annular shape (e.g. a circle), and the ends of the band may thereafter be connected by a metal-adhesive tape. The method 400 further comprises the step 420 of extruding a sealing element comprising a slit for at least partially accommodating the band and at least two deformable portions oppositely arranged at respective peripheral edge portions of the slit. Furthermore, the method 400 comprises the step 430 of arranging the sealing element at least partially around the band. Optionally, the method 400 may further comprise the step of perforating at least one of the deformable portions of the sealing member.

The person skilled in the art realizes that the present invention by no means is limited to the preferred embodiments described above. On the contrary, many modifications and variations are possible within the scope of the appended claims. For example, it will be appreciated that the figures are merely schematic views of a sealing member according to embodiments of the present invention. Hence, any elements/components of the sealing member 100 such as the band 110, the sealing element 120, the slit 130 and/or the deformable portions 140a, 140b may have different dimensions, shapes and/or sizes than those depicted and/or described. For example, the deformable portions 140a, 140b may be larger or smaller than what is exemplified in the figures.

1. A sealing member for providing a sealing between two inter-attachable parts, the sealing member comprising
a band comprising two elongated, oppositely arranged ridges defining a width W of the band, and
a sealing element comprising at least two deformable portions mutually connected by a support wall and oppositely arranged at respective peripheral edge portions of a slit,
the slit comprises two grooved seats, one at each a peripheral portion, and a slit wall comprising the support wall and two lips opposite the support wall and on either side of an insertion opening,
the band is at least partially accommodated in the slit with the support wall adjacent to a major face of the band and with the ridges of the band seated in a respective grooved seat,
wherein the support wall of the sealing element connecting the at least two deformable portions abuts the major face of the band.

2. The sealing member according to claim 1, wherein the sealing member is annular.

3. The sealing member according to claim 1, wherein at least one of the deformable portions comprises a cavity.

4. The sealing member according to claim 1, wherein both the deformable portions comprise a cavity.

5. The sealing member according to claim 3, wherein at least one of the deformable portions comprises at least one perforation.

6. The sealing member according to claim 1, wherein the band is made of ductile/pliant material.

7. A sealing arrangement, comprising
two inter-attachable parts,
a sealing member according to any one of the preceding claims, for providing a sealing between the two inter-attachable parts,
wherein the sealing member is arranged between the parts and oriented such that the deformable portions are configured to abut a respective part upon an attachment of the parts.

8. The sealing arrangement according to claim 7, further comprising a frame arranged at a peripheral portion of the parts, wherein the frame is configured to clamp the parts.

9. A lighting arrangement, comprising
a heat sink,
an optical element arranged oppositely the heat sink,
a light source for generating light, the light source being arranged between the heat sink and the optical element, and
a sealing member according to claim 1,
wherein the sealing member is arranged between the heat sink and the optical element for sealing the light source, and wherein the sealing member is oriented such that the deformable portions are configured to abut the respective heat sink and optical element upon an attachment of the heat sink and the optical element.

10. The lighting arrangement according to claim 9, wherein the optical element is a translucent plate.

11. The lighting arrangement according to claim 9, further comprising a frame arranged at a peripheral portion of the lighting arrangement, wherein the frame is configured to clamp the heat sink and the optical element.

12. Method of producing a sealing member, comprising
providing a band having two elongated, oppositely arranged ridges;
extruding a sealing element comprising a slit having two grooved seats for at least partially accommodating the band and at least two deformable portions mutually connected by a support wall and oppositely arranged at respective peripheral edge portions of the slit; and
arranging the sealing element at least partially around the band with the support wall adjacent to a major face of the band and with the ridges of the band seated in a respective grooved seat.

13. The method according to claim 12, further comprising
forming the sealing member to an annular sealing member.

14. The method according to claim 12, further comprising
providing a cavity in at least one of the deformable portions.

15. The method according to claim 14, further comprising
perforating at least one of the deformable portions of the sealing member.
